(19) United States
(12) Patent Application Publication
(10) Pub. No.: US 2025/0189082 A1
(43) Pub. Date: Jun. 12, 2025

(54) A CAP FOR A GAS CANISTER; ASSEMBLY COMPRISING A GAS CANISTER PROVIDED WITH SAID CAP AND A PERSONAL PROTECTIVE DEVICE WITH AN INFLATABLE BAG CONNECTED TO SAID ASSEMBLY

(71) Applicant: ALPINESTARS RESEARCH S.P.A., Maser (TV) (IT)

(72) Inventors: Giovanni MAZZAROLO, Coste di Maser (TV) (IT); Lorenzo NARDO, Ponzano Veneto (TV) (IT); Riccardo FAGGIAN, Dolo (VE) (IT)

(21) Appl. No.: 18/845,772

(22) PCT Filed: Mar. 21, 2023
(86) PCT No.: PCT/IB2023/052760

§ 371 Date: Sep. 10, 2024

(30) Foreign Application Priority Data
Mar. 22, 2022 (IT) 102022000005552

(51) Int. Cl. F17C 13/06

(52) U.S. Cl. CPC F17C 13/06; F17C 2205/0311; F17C 2270/0772

(57) ABSTRACT

A cap configured to be fastened to a gas canister. The cap includes a main body provided with at least one hole. The cap includes an appendix which protrudes from the main body. The appendix is provided with a deviation surface which is arranged facing the at least one hole so as to deflect a fluid exiting the at least one hole. Also provided is an assembly including a gas canister provided with the cap. Further provided is a personal protective device with an inflatable bag connected to said assembly.

The present invention relates to a cap for a gas canister. Moreover, the present invention relates to an assembly comprising a gas canister provided with said cap. Furthermore, the present invention relates to a personal protective device with an inflatable bag connected to said assembly.

Gas canisters are used in a great number of devices and situations, such as for instance the inflation of bags inserted in personal protective devices also known as “air bags”. For sake of simplicity, but without limiting function, hereinafter reference will be made to gas canisters used in personal protective devices provided with inflatable bags.

As it is well known in the art, personal protective devices provided with inflatable bags have been developed to protect users from injuries coming from impacts during different kinds of activity, such as riding motorcycles, cycling, walking, or during industrial working activities.

Generally, the personal protective devices comprise a protective garment, like a jacket, a vest, a gilet, a suit, a belt, inside which at least one inflatable bag is arranged. The inflatable bag is designed to be inflated for moving from a deflated status into an inflated status when a danger situation for the user is detected.

The personal protective devices generally comprise at least one gas canister, designed to contain the inflation fluid of the inflatable bag, and an activation mechanism, designed to trigger the gas canister. It is well known in the art that the activation mechanism of the personal protection device can be of mechanical or electronic type.

Due to the need for a small footprint, the gas canisters must have small sizes, consequently the inflation fluid is stored inside them under high pressure.

At the same time, when a dangerous situation for the user is detected by the activation mechanism, the inflation of the inflatable bag needs to be as quick as possible so that the bag can rapidly reach the inflated status for offering an improved protection to the user.

The need to have an inflation fluid stored under high pressure inside the gas canister and to obtain a quick inflation of the inflatable bag determines that a high inflation fluid flow rate comes out from the gas canister when the latter is triggered. As a matter of fact, most of the inflation fluid comes out from the corresponding gas canister in a time of the order of a few tenths of milliseconds or even lower.

This occurrence produces high stresses on the near objects, for example the inflatable bag or the connecting elements between the gas canister and the inflatable bag, with a not negligible risk of damages or ruptures.

Moreover, to allow a quick release of the inflation fluid from the gas canister, the latter generally contains pyrotechnic material which results in high temperatures of the inflation fluid. Such high temperatures can favour tearings and damages in the bag.

To overcome such drawbacks it is known to mount an additional component called “cap” in proximity to the outlet of the gas canister.

Depending on the gas canister design, this cap can be removably fastened to the gas canister, for example by means of screwing or clamping, or it can be rigidly and permanently fastened to the gas canister, for example by means of welding.

The function of the cap is to act as a shield interposed between the gas canister and the near objects, avoiding that such objects may be directly hit by the inflation fluid exiting from the gas canister.

In detail, the cap is fastened to the gas canister so that the inflation fluid coming out from the gas canister passes through the cap and exits from one or different holes provided in the cap itself.

The cap also accomplishes a further function, namely to act as a brake for slowing down the flow of the inflation fluid.

As a matter of fact, the cap is able to reduce the speed of the inflation fluid and to distribute into a longer time the entrance of the inflation fluid into the inflatable bag, so as to protect the inflatable bag and to obtain a more uniform pressure inside it.

Moreover, in the personal protection devices the cap also has the function to allow a quick change of the gas canister once the inflatable bag has been activated becoming empty.

As a matter of fact, the cap is usually fastened at the inlet of the inflatable bag, so as to permit an indirect connection between gas canister and inflatable bag which results in the possibility to quick change the gas canister without affecting the air tightness connection between the gas canister and the inflatable bag.

Even if the use of the caps is appreciated, the gas canisters normally used in the personal protection devices have still a further drawback.

As a matter of fact, when the inflation fluid comes out of the gas canister, even in the presence of the cap, a reaction force is generated according to Newton's third law of motion. The magnitude and the direction of the reaction force depend on the value of the inflation fluid flow rate and its direction, which are determined by the constructive and geometrical characteristics of the gas canister or of the assembly formed by the gas canister and cap.

If the gas canister directs the gas flow into a single direction, it thus undergoes a reaction force directed into the opposite direction.

This reaction force can be dangerous since if the gas canister is not properly fixed to the inflatable bag it can be ejected into space with the risk of hitting something or somebody nearby.

At the same time, such a reaction force is in any case present even if the gas canister is properly fixed to the inflatable bag. The bag can mitigate this force but in this occurrence the risk exists that the inflatable bag might be damaged.

The condition of a gas canister not properly fixed to the inflatable bag is created during the so-called bonfire test which needs to be passed by the airbag system for obtaining the corresponding certification. Such a test has the aim to verify that in case of a firing, no one of the components of the airbag system is thrown over a certain distance. During such a test, the whole personal protection device is burned down. During the burning, unavoidably the connection between the inflatable bag and the gas canister is damaged and the inflation fluid contained inside the gas canister is released with the latter that can be ejected into the surrounding space with the related risks.

The main object of the present invention is therefore to provide a cap for a gas canister designed to overcome or at least reduce the drawbacks mentioned above with reference to the known caps.

More specifically, the main object of the present invention is to provide a cap for a gas canister able to reduce the reaction force exerted on the gas canister in case of an improper connection between the gas canister and the inflatable bag.

Another object of the present invention is to provide a cap for a gas canister suitable for reducing the stresses acting at the connection between the gas canister and the inflatable bag, once the gas canister is triggered.

A further object of the present invention is to provide an assembly formed by a cap and a gas canister which allows to uniformly distribute the inflation fluid inside the inflatable bag, without affecting the inflation speed.

Finally, an object of the present invention is to provide a personal protection device with an inflatable bag able to pass the bonfire test without needing a change in the geometry of the gas canister.

The above mentioned objects, and other objects that will better appear from the following description, are achieved by a cap for a gas canister according to claim 1, by an assembly, comprising a gas canister and a cap, according to claim 13 and by a personal protection device, provided with an inflatable bag, according to claim 14.

The advantages and the characteristic features of the present invention will appear more clearly from the following description of preferred, but not exclusive, embodiments of the cap for a gas canister, illustrated in the accompanying figures in which:

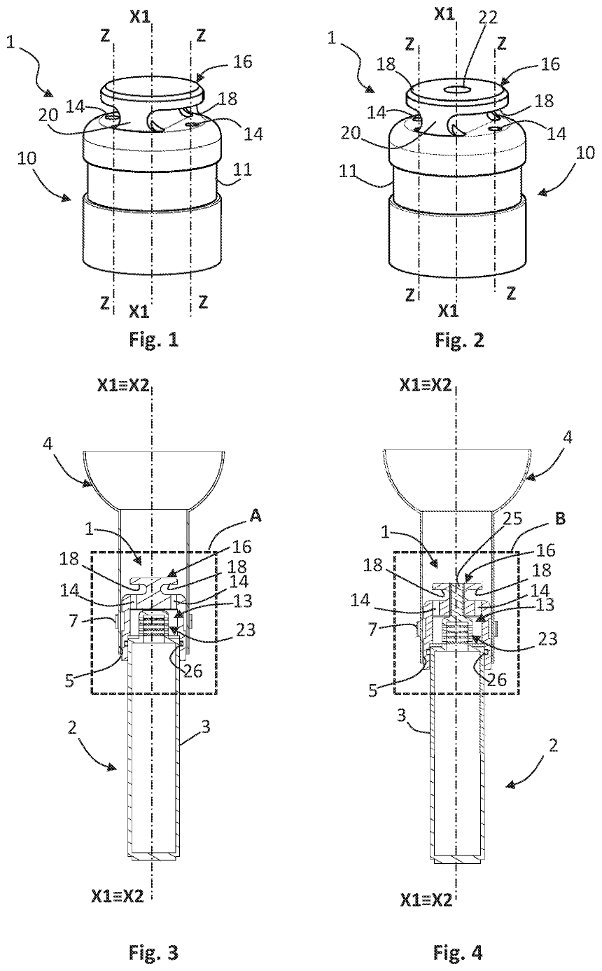

FIG. 1 shows, in schematic form, a perspective view of a cap for a gas canister according to a first embodiment of the present invention;

FIG. 2 shows a view similar to FIG. 1 but relating to a second embodiment;

FIG. 3 shows, in schematic form, a cross-sectioned view of the assembly formed by the cap of FIG. 1 and a gas canister according to the present invention;

FIG. 4 shows, in schematic form, a cross-sectioned view of the assembly formed by the cap of FIG. 2 and a gas canister according to the present invention;

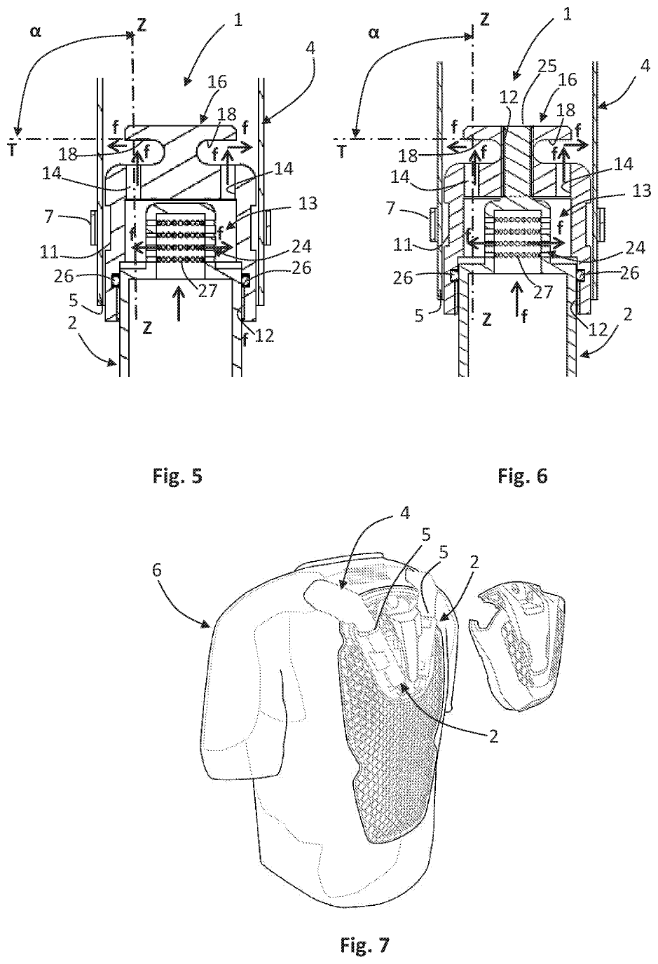

FIG. 5 shows an enlarged view of the detail of FIG. 3 identified by the letter A;

FIG. 6 shows an enlarged view of the detail of FIG. 4 identified by the letter B;

FIG. 7 shows a rear perspective view of a personal protective device provided with an inflatable bag according to the present invention;

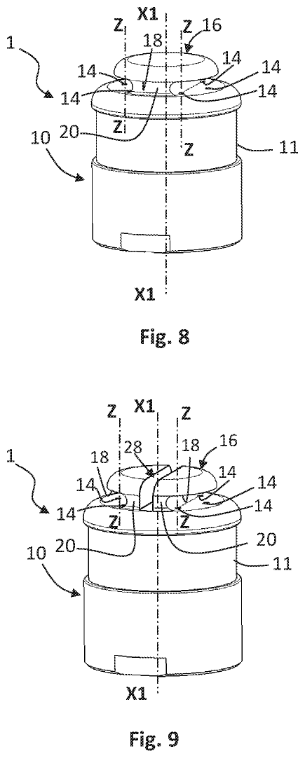

FIGS. 8 and 9 show views similar to FIG. 1 but relating to different embodiments.

In the following description of a cap for a gas canister according to the invention, as “inner” there will be indicated the part or component of the cap which, during the normal use, is relatively closer to the gas canister and as “outer” the part or component relatively farther.

With reference to the attached figures, an example of a cap for a gas canister according to the invention is indicated as a whole by the reference 1.

In particular, said cap 1 is preferably configured to be fastened to a gas canister 2 designed to be connected in its turn to an inflatable bag 4 of a personal protection device 6, like the one shown in FIG. 7.

The personal protection device 6 can be for example a garment, like a vest, a jacket, a suit, or alternatively a harness.

As shown in FIGS. 1 and 2, the cap 1 comprises a main body 10 which is provided with at least one hole 14.

According to the invention, the cap 1 comprises an appendix 16 which protrudes from the main body 10. The appendix 16 is provided in its turn with a deviation surface 18 which is arranged facing said at least one hole 14 so as to deflect a fluid exiting said at least one hole 14.

In particular, a terminal portion of the hole 14, namely the portion close to the deviation surface 18, can extend along an axis Z and the deviation surface 18 can be inclined at an angle of deviation a relative to said axis Z.

In this way, when the cap 1 is fastened to a gas canister 2, the deviation surface 18 intercepts and deflects at least a portion of the inflation fluid exiting the gas canister 2 after the passage of said inflation fluid into the at least one hole 14.

As it will clearly appear from the following description, the cap 10 thanks to the provision of the deviation surface 18 is able to direct the inflation fluid exiting the gas canister 2 along preferred directions.

In particular, the cap is able to direct the inflation fluid exiting the gas canister along directions which are inclined with respect to a longitudinal axis of the gas canister. In this way, the reaction force acting on the gas canister following its triggering will be no longer directed along the longitudinal axis X thereof, overcoming the problems before mentioned.

Moreover, the possibility to direct the inflation fluid along preferred directions also permits to reduce the stresses acting at the interface surface between the inflatable bag and the gas canister, in case the latter is used to inflate an inflatable bag of a personal protection device. In this way the risk of tearings or ruptures at the connection between the inflatable bag and the gas canister is reduced.

Preferably, the cap 1 is made of rigid material. More preferably the cap 1 is made with a metallic material to withstand the high pressure, in the range of 400 bar, exerted by the inflation fluid exiting the gas canister 2.

The cap 1, as shown for example in FIGS. 1-2, can be formed by a single element. Alternatively, the cap 1 can be formed by two or more elements designed to be connected to each other. For example the appendix 16 can be connected by screwing to the main body 10.

The main body 10 has preferably a cylindrical shape.

Advantageously, the main body 10 can be provided with a perimetrical recess 11 running along the outer surface of the main body 10.

As clearly shown in FIGS. 3-6, the main body 10 can be provided with an internal cavity 13 open at its bottom side, namely on the side opposite to the deviation surface 18.

The cavity 13 can be configured to house a terminal end 23 of the gas canister 2. In particular, as it will be disclosed in detail in the following, the cavity 13 is configured to house the terminal end 23 of the gas canister 2 provided with an outlet valve 24 through which the inflation fluid stored inside the gas canister 2 is expelled (see FIGS. 5-6).

The inner surface of the cavity 13 can be provided with a seat for housing a sealing ring 26 which has the function to guarantee that no leakage is present between the cap 1 and the gas canister 2 once these components are assembled with each other.

As shown in the enclosed figures, the at least one hole 14 can be a through hole. In this case, the axis Z represents a longitudinal axis of the hole 14.

Preferably, said at least one hole 14 is arranged on the main body 10 so as to put in fluid communication the internal cavity 13 with an external portion of the cap 1.

Preferably, the main body 10 is provided with a plurality of holes 14 (see FIGS. 1-2 and 8-9). Advantageously, as shown in FIGS. 1-2 and in FIGS. 8-9, said holes 14 can have their respective axes Z parallel to each other and parallel to a longitudinal axis X1 of the main body 10.

Preferably, each hole 14 is arranged along a perimetral portion of the main body 10. In particular, the holes 14 can be arranged along a circular line so as to be equally spaced from each other.

Moreover, each hole 14 can have different dimensions depending on the inflation fluid flow rate which needs to be obtained.

In particular, each hole 14 can have a constant cross-section along a major part of its length.

The holes 14 can have a circular section. More preferably, the holes 14 have the same dimensions, namely the same cross-section and the same length.

However, different arrangements of the holes 14 are possible depending on the size of the gas canister 2 to which the cap 1 needs to be fastened. For example, the holes 14 provided in the main body 10 of the cap 1 of FIGS. 1-2 have a cross-section greater than the holes 14 of the cap 1 of FIGS. 8-9.

The appendix 16 can protrude from a top surface of the main body 10 along a direction which is opposite to the internal cavity 13. Consequently, as top surface of the main body 10 it is identified the surface of the main body 10 wherein the at least one hole 14 is arranged.

Preferably, the appendix 16 extends along the longitudinal axis X1 of the main body 10.

More preferably, the appendix 16 comprises at least one stem 20 protruding from the top surface of the main body 10.

As shown in the enclosed figures, the deviation surface 18 is arranged at a terminal end of the appendix 16, namely at the end of the appendix 16 which is farther from the top surface of the main body 10. In other words, the deviation surface 18 is external to the main body of the cap. Specifically, as clearly shown in the enclosed figures, the deviation surface 18 is spaced apart from the top surface of the main body 10.

In case the appendix 16 comprises at least one stem 20, the deviation surface 18 is arranged at the terminal end of said stem 20, namely at the end of the stem 20 which is farther from the top surface of the main body 10.

Preferably the deviation surface 18 consists of an elongated element lying on a plane T (see FIGS. 5 and 6) which is inclined of the angle of deviation α with respect to the axes Z of the holes 14.

Advantageously, the deviation surface 18 can consist of an element having the shape of a disc. Alternatively, the deviation surface 18 can be a flat surface having a polygonal shape, for example square or pentagonal shape.

In a further embodiment, not shown in the enclosed figures, the deviation surface can consist of a V-shaped element, the sides of the V-shaped element both defining a deviation angle α.

As shown in the enclosed figures, the deviation surface 18 is spaced apart from the holes 14. The deviation surface 18 is designed to be superimposed over each hole 14 of the main body 10. In other words, the deviation surface 18 has shape and dimensions able to intercept the inflation fluid coming from the holes 14 when the cap 1 is connected to the gas canister 2.

The deviation surface 18 can be inclined at an angle of deviation α between 30° and 90°, preferably between 50° and 90° and even more preferably between 70° and 90°.

In the enclosed figures, as an example, it is shown a cap 1 having a deviation surface 18 which is inclined at an angle of deviation α of about 90° relative to the axes Z of the holes 14.

As shown in FIG. 2, the cap 1 can be provided with a longitudinal opening 22 in fluid communication with the internal cavity 13. Preferably, the longitudinal opening 22 can extend from the internal cavity 13 towards the deviation surface 18.

The internal cavity 13 and/or the longitudinal opening 22 can be provided with fastening means 12 designed to cooperate with corresponding fastening means provided on the gas canister 2 (see FIGS. 5-6).

For example, the fastening means 12 can consist of internal threads suitable for being screwed into a corresponding external thread provided on the gas canister 2.

Alternatively, as shown in FIG. 8, the appendix 16 can be provided with a groove 28. Said groove 28 is suitable for dividing the appendix 16 in two appendixes, each appendix being provided with a stem and a deviation surface.

As anticipated, the present invention also relates to an assembly comprising a gas canister 2, designed to be connected to the inflatable bag 4 of the personal device 6 for moving the inflatable bag 4 from a deflated status into an inflated status, and the cap 1.

The gas canister 2 comprises a terminal end 23 which is provided with an outlet valve 24. Through the outlet valve 24 the inflation fluid of the inflatable bag 4 stored inside the gas canister 2 is expelled.

In particular, the cap 1 is fastened to the gas canister 2 so as to enclose said terminal end 23.

According to the invention, the cap 1 is fastened to the gas canister 2 by arranging each hole 14 parallel to the longitudinal axis X2 of the gas canister 2. Preferably, the axis Z along which the terminal portion of each hole extends is arranged parallel to the axis X2.

As shown for example in FIGS. 3-4, the cap 1 can be fastened to the gas canister 2 with the longitudinal axis X1 of the main body 10 coinciding with the longitudinal axis X2 of the gas canister 2.

As it is shown in the enclosed figures, the outlet valve 24 can consist of a plurality of apertures 27 arranged along the perimetral surface of the terminal end 23.

Preferably, the cap 1 is fastened to the gas canister 2 in a gas-tight manner so as to avoid a leakage of inflation fluid between these components once the gas canister 2 is triggered.

As shown in the enclosed figure, the cap 1 can be fastened to the gas canister 2 by arranging said terminal end 23 inside the internal cavity 13 (see FIGS. 3-4).

The terminal end 23 extends from a main body 3 of the gas canister 2 and it is dimensioned so as to leave a given space between its outer surface and the inner surface of the internal cavity 13 (see FIGS. 5 and 6). At the same time, the outer surface of the main body 3 close to the terminal end 23 is designed to abut against the inner surface of the internal cavity so as to seal the bottom end thereof.

In the embodiment shown in FIGS. 4 and 6, the terminal end 23 is provided with a longitudinal stud 24 which is designed to be housed inside the longitudinal opening 22 of the cap 1.

The cap 1 can be fastened to the gas canister by means of the fastening means 12 provided at the internal cavity 13 and/or at the longitudinal opening 22 designed for cooperating with corresponding fastening means provided on the gas canister 2.

The present invention also relates to a personal protection device 6 comprising an inflatable bag 4 designed to move between a rest condition, wherein it is in a deflated status, and an operating condition, wherein it is in an inflated status.

The personal protection device 6 comprises the assembly previously disclosed which is formed by the cap 1 and the gas canister 2, wherein the cap 1 is fastened at an opening 5 of the inflatable bag 4.

Once the gas canister 2 is triggered, the inflation fluid stored therein can flow inside the inflatable bag 4 so as to move it from its rest condition, wherein it is in a deflated status, into the operating condition, wherein it is in an inflated status

[symbol]

The gas canister 2 can be chosen from the group comprising pyrotechnic inflators, compressed gas inflators and hybrid inflators.

As schematically shown in FIGS. 3-6, the cap 1 is preferably clamped in a gas tightly manner at the opening 5 of the inflatable bag 4 by means of a holding ring 7 designed to be superimposed to the perimetric recess 11.

Consequently, when the cap 1 is fastened in a gas-tight manner to the inflatable bag 4, the gas canister 2 itself is connected in a gas-tight manner to the inflatable bag 4.

Moreover, such an arrangement of the cap 1 with respect to the inflatable bag 4 permits the user of the personal protection device to easily change the gas canister once exhausted without being worried to affect the gas-tight connection between the inflatable bag 4 and the assembly formed by the gas canister 2 and the cap 1.

In the following it will be disclosed how the cap 1 works once the assembly formed by the cap 1 and the gas canister 2 is fastened at the opening 5 of the inflatable bag 4 of the personal protection device 6.

Thanks to the mutual arrangement between the cap 1 and the gas canister 2, the cap 1 permits to direct the inflation fluid exiting the outlet valve 24 along a direction which is inclined of the deviation angle α with respect to the longitudinal axis X2 of the gas canister 2.

As a matter of fact, once the gas canister 2 is triggered, the inflation fluid coming from the outlet valve 24 firstly occupied the internal cavity 13.

Being the internal cavity sealed at its bottom end, the inflation fluid is forced to flow through the holes 14 of the cap 1. In this way the inflation fluid is divided into different inflation flows and it can be uniformly channeled along the circumference of the main body 10 to uniformly distribute the pressure exerted by the inflation fluid along the interface between the inflatable bag and the cap.

Moreover, thanks to the mutual arrangement between the holes 14 and the deviation surface 18, once the inflation fluid exits from the holes 14, it unavoidably hits the deviation surface 18 so as to be deflected.

In particular, the provision of the deviation surface 18 permits to reduce or to delete the speed axial component of the various inflation flows exiting the holes 14, so as to redirect them along directions which are substantially perpendicular to the longitudinal axis X2 of the gas canister 2. The path followed by the inflation fluid exiting the gas canister 2 towards the cap 1 is schematically indicated in FIGS. 5 and 6 by the arrows f.

In this way, the objects positioned near the cap, like the bag, are protected against tearing. Moreover, in case of firing, the cap 1 permits to obtain a relevant reduction of the reaction force acting on the gas canister.

It is clear now how the present invention allows to achieve the predefined objects.

As a matter of fact, the provision of the cap 1 permits to reduce the reaction force exerted on the gas canister in case of an improper connection between the gas canister and the inflatable bag or in case of firing.

As a matter of fact, the risk that objects and people near the personal protection device provided with the inflatable bag can be hit by flying debris is reduced.

Moreover, the cap thanks to the combination of the holes on the main body with the deviation surface permits to reduce the stress acting on the connection between the gas canister and the inflatable bag, once the gas canister is triggered.

Furthermore, as already noted, the provision of the cap permits to uniformly distribute the inflation fluid inside the bag without affecting the inflation of the latter.

In particular, the provision of the cap allows to deflect and to distribute in a symmetric and lateral way the gas flow exiting from the gas canister.

Lastly, the personal protection device provided with the cap is able to easily pass the bonfire test envisaged to obtain the required safety certification, since the reaction force acting on the gas canister is strongly reduced thanks to the redirection of the inflation fluid.

With regard to the embodiments of the cap described above, the person skilled in the art may, in order to satisfy specific requirements, make modifications to and/or replace elements described with equivalent elements, without thereby departing from the scope of the accompanying claims.

1. A cap for a gas canister, comprising:
a main body provided with at least one hole;
characterized in that the cap comprises an appendix which protrudes from the main body;
said appendix being provided with a deviation surface which is arranged facing said at least one hole so as to deflect a fluid exiting said at least one hole.

2. The cap according to claim 1, characterized in that a terminal portion of said at least one hole extends along an axis, said deviation surface being inclined at an angle of deviation relative to said axis.

3. The cap according to claim 1, characterized in that said deviation surface is arranged at a terminal end of the appendix.

4. The cap according to claim 1, characterized in that the appendix comprises at least one stem protruding from a top surface of the main body, the deviation surface being arranged at a terminal end of said at least one stem.

5. The cap according to claim 1, characterized in that the deviation surface consists of an elongated element lying on a plane, said plane being inclined of said angle of deviation with respect to the axis.

6. The cap according to claim 1, characterized in that said deviation surface is spaced apart from said at least one hole.

7. The cap according to claim 1, characterized in that the deviation surface is inclined at an angle of deviation between 30° and 90°.

8. The cap according to claim 1, characterized in that the main body is provided with an internal cavity open at its bottom side, said internal cavity being configured to house a terminal end of the gas canister.

9. The cap according to claim 8, characterized in that said at least one hole is arranged on the main body so as to put in fluid communication the internal cavity with an external portion of the cap.

10. The cap according to claim 1, characterized in that the main body is provided with a plurality of holes, each hole of said plurality being arranged along a perimetral portion of the main body.

11. The cap according to claim 10, characterized in that the holes of said plurality have their respective longitudinal axes parallel to each other and parallel to a longitudinal axis of the main body.

12. The cap according to claim 11, characterized in that the holes of said plurality are arranged along a circular line, said holes being equally spaced from each other.

13. An assembly comprising:
a gas canister designed to be connected to an inflatable bag of a personal protection device for moving the inflatable bag from a deflated status into an inflated status, said gas canister comprising a terminal end provided with an outlet valve through which the inflation fluid of the inflatable bag stored inside the gas canister is expelled;
a cap comprising:
a main body provided with at least one hole;
characterized in that the cap comprises an appendix which protrudes from the main body, said appendix being provided with a deviation surface which is arranged facing said at least one hole so as to deflect a fluid exiting said at least one hole, the cap fastened to the gas canister so as to enclose said terminal end;
characterized in that the cap is fastened to the gas canister by arranging the axis of said at least one hole parallel to a longitudinal axis of the gas canister.

14. A personal protection device comprising:
an inflatable bag designed to move between a rest condition in a deflated status and an operating condition in an inflated status; and
an assembly comprising:
a gas canister designed to be connected to an inflatable bag of a personal protection device for moving the inflatable bag from a deflated status into an inflated status, said gas canister comprising a terminal end provided with an outlet valve through which the inflation fluid of the inflatable bag stored inside the gas canister is expelled;
a cap comprising:
a main body provided with at least one hole;
characterized in that the cap comprises an appendix which protrudes from the main body, said appendix being provided with a deviation surface which is arranged facing said at least one hole so as to deflect a fluid exiting said at least one hole, the cap fastened to the gas canister so as to enclose said terminal end;
characterized in that the cap is fastened to the gas canister by arranging the axis of said at least one hole parallel to a longitudinal axis of the gas canister, the cap of said assembly being fastened at an opening of the inflatable bag.

15. The cap according to claim 7, characterized in that the deviation surface is inclined at an angle of deviation between 50° and 90°.

16. The cap according to claim 15, characterized in that the deviation surface is inclined at an angle of deviation between 70° and 90°.
